(19) United States
(12) Patent Application Publication
(10) Pub. No.: US 2016/0342068 A1
(43) Pub. Date: Nov. 24, 2016

(54) Camera Motor and Electronic Device

(71) Applicants: Beijing Lenovo Software Ltd., Beijing (CN); Lenovo (Beijing) Co., Ltd., Beijing (CN)

(72) Inventor: Jiefeng CHEN, Beijing (CN)

(73) Assignees: BEIJING LENOVO SOFTWARE LTD., Beijing (CN); LENOVO (BEIJING) CO., LTD., Beijing (CN)

(21) Appl. No.: 14/856,030

(22) Filed: Sep. 16, 2015

(30) Foreign Application Priority Data
May 20, 2015 (CN) 201510259400.9
May 25, 2015 (CN) 201510271071.X

(51) Int. Cl. G03B 5/00; H04N 5/232; G03B 13/36; H04N 5/225; G02B 7/09; G02B 27/64

(52) U.S. Cl. CPC G03B 5/00; G02B 7/09; G02B 27/646; G03B 13/36; H04N 5/2257; H04N 5/2254; H04N 5/23287

(57) ABSTRACT

It is disclosed according to the present application a camera motor and an electronic device. The camera motor includes: a lens assembly, a coil set, a holder, a coil bobbin assembly and a base. The coil set includes an optical image stabilizer coil and an autofocusing coil. The lens assembly is connected with the coil set, and the coil set is arranged in the holder, and the holder is arranged in the coil bobbin assembly, and the coil bobbin assembly is arranged in the base.

The present application claims the priority to Chinese Patent disclosure No. 201510259400.9, entitled as “CAMERA MOTOR AND ELECTRONIC DEVICE”, filed on May 20, 2015 with State Intellectual Property Office of People's Republic of China, which is incorporated herein by reference in its entirety.

The present application claims the priority to Chinese Patent disclosure No. 201510271071.X, entitled as “CAMERA MOTOR AND ELECTRONIC DEVICE”, filed on May 25, 2015 with State Intellectual Property Office of People's Republic of China, which is incorporated herein by reference in its entirety.

### FIELD

This application relates to the field of mechanical design techniques, and particular to a camera motor and an electronic device.

### BACKGROUND

Currently, in a camera motor of a mobile device such as a cellphone, generally, with respect to a lens assembly, a coil bobbin assembly is required to be arranged in a holder first, and then the holder with the coil bobbin assembly is disposed in an image stabilizing coil and a focusing coil, thereby allowing a power generated by the image stabilizing coil to push the lens and the coil bobbin assembly part, hence, a magnetic coil of an assembly of an image stabilizing part is required to be made large. However, if the magnetic coil of the assembly of the image stabilizing part is made large, not only the volume of the entire camera motor is caused to be large, but also the overall weight of the device provided with the camera motor is increased, thus impacting an experience of a user during using.

### SUMMARY

An object of the present application is to provide a camera motor and an electronic device, to solve the technical problem that the volume of the camera motor is large, also the overall weight of the device is increased, and an experience of a user during using is impacted.

In one aspect, it is provided according to the present application a camera motor. The camera motor includes:

a lens assembly, a coil set, a holder, a coil bobbin assembly and a base, the coil set includes an optical image stabilizer coil and an autofocusing coil;

wherein the lens assembly is connected with the coil set, and the coil set is arranged in the holder, and the holder is arranged in the coil bobbin assembly, and the coil bobbin assembly is arranged in the base.

In another aspect, it is further provided according to the present application an electronic device, the electronic device includes a camera motor;

wherein the camera motor includes:

a lens assembly, a coil set, a holder, a coil bobbin assembly and a base, the coil set includes an optical image stabilizer coil and an autofocusing coil;

wherein the lens assembly is connected with the coil set, and the coil set is arranged in the holder, and the holder is arranged in the coil bobbin assembly, and the coil bobbin assembly is arranged in the base.

As can be seen from the above solution, in the camera motor according to a first embodiment of the present application, by changing the mounting sequence of the coil bobbin assembly and the coil set, that is to say, the lens assembly in the camera motor is connected with the coil set, the coil set is arranged in the holder, the holder is arranged in the coil bobbin assembly, and the coil bobbin assembly is then arranged in the base, thus reducing the power which is required to be provided by the coil set in pushing, thereby may reduce the volume of the coil, and further reduce the volume of the camera motor and the overall weight of the device provided with the camera motor, and improve the experience of the user during using, and achieve the object of this embodiment.

### BRIEF DESCRIPTION OF THE DRAWINGS

In order to more clearly illustrate embodiments of the present application or the technical solutions in the conventional technology, drawings referred to describe the embodiments or the conventional technology will be briefly described hereinafter. Apparently, the drawings in the following description are only embodiments of the present application, and for the person skilled in the art, other drawings may be obtained based on the drawings provided without any creative efforts.

FIG. 1 is a schematic diagram showing the structure of a camera motor according to an embodiment of the present application;

FIG. 2 is a schematic diagram showing the structure of a camera motor according to an embodiment of the present application;

FIG. 3 is a schematic diagram showing the structure of a camera motor according to an embodiment of the present application;

FIG. 4 is a schematic diagram showing another structure according to an embodiment of the present application; and

FIG. 5 is a schematic diagram showing the structure of an electronic device according to an embodiment of the present application;

FIG. 6 is a schematic diagram showing the structure of a camera motor according to an embodiment of the present application;

FIG. 7 is a schematic diagram showing the structure of a camera motor according to an embodiment of the present application;

FIG. 8 is a schematic diagram showing a partial structure of the embodiment of the present application;

FIG. 9 is a schematic diagram showing the structure of a camera motor according to an embodiment of the present application;

FIG. 10 is a schematic diagram showing a partial structure of the embodiment of the present application;

FIG. 11 is a schematic diagram showing the structure of a camera motor according to an embodiment of the present application;

FIG. 12 is a schematic diagram showing the structure of a camera motor according to an embodiment of the present application; and

FIG. 13 is a schematic diagram showing the structure of an electronic device according to an embodiment of the present application.

### DETAILED DESCRIPTION

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the scope of the present application.

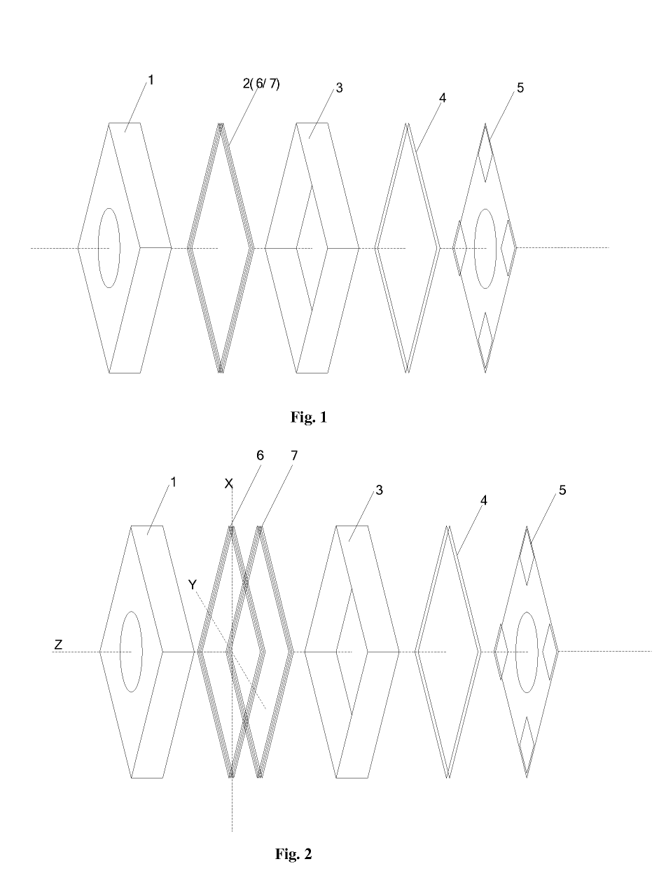

Reference is made to FIG. 1, which is a schematic diagram showing the structure of a camera motor according to an embodiment of the present application. In this embodiment, the camera motor may be arranged in a device having a camera function, such as a cellphone, a pad, a single-lens reflex camera.

In this embodiment, the camera motor may include the following components:

a lens assembly 1, a coil set 2, a holder 3, a coil bobbin assembly 4 and a base 5. The coil set 2 includes an optical image stabilizer coil 6 and an autofocusing coil 7.

The lens assembly 1 is connected with the coil set 2, the coil set 2 is arranged in the holder 3, the holder 3 is arranged in the coil bobbin assembly 4, and the coil bobbin assembly 4 is arranged in the base 5.

It is to be noted that, the lens assembly 1 in this embodiment may be an assembly which has a square structure at an outer periphery and has a circular structure at an inner side, as shown in FIG. 1, to allow the circular lens to collect lights via the circular structure of its inner side and further to form an image.

The lens assembly 1 may be configured as a groove structure, as shown in FIG. 1, to allow other components including the coil set 2 to be moved towards a left side in FIG. 1, and further to be embedded into the lens assembly 1, to achieve the connection of the lens assembly 1 and the coil set 2 to each other.

In practical application, the coil set 2 may be arranged in the holder 3. For the coil set 2, the holder 3 may function to support the coils to maintain a certain shape, and the holder 3 can be arranged in the coil bobbin assembly 4, and the coil set 2 is supported by the coil bobbin assembly 4 via the holder.

Correspondingly, the coil bobbin assembly 4 may be embedded into the base 5, and the base 5, after enclosing the coil bobbin assembly 4, the holder 3, the coil set 2, is connected with the lens assembly 1, for example, by snap-fit connection or nested connection.

As shown in FIG. 1, the coil set 2 may achieve the forward-and-backward moving of the lens assembly 1 simply by pushing the lens assembly 1 in front of the coil set 2, without requiring pushing the structures such as the holder 3, and the coil bobbin assembly 4, and further without requiring a large pushing force, therefore the number of the coils in the coil set may be reduced, and thus the volume of the coil set may be reduced.

As can be seen from the above solution, in the camera motor according to this embodiment of the present application, by changing the mounting sequence of the coil bobbin assembly and the coil set, that is to say, the lens assembly in the camera motor is connected with the coil set, the coil set is arranged in the holder, the holder is arranged in the coil bobbin assembly, and the coil bobbin assembly is then arranged in the base, the power which is required to be provided by the coil set in pushing is reduced, thus may reduce the volume of the coil, and further reduce the volume of the camera motor and the overall weight of the device provided with the camera motor, and improve an experience of a user during using, and achieve the object of this embodiment.

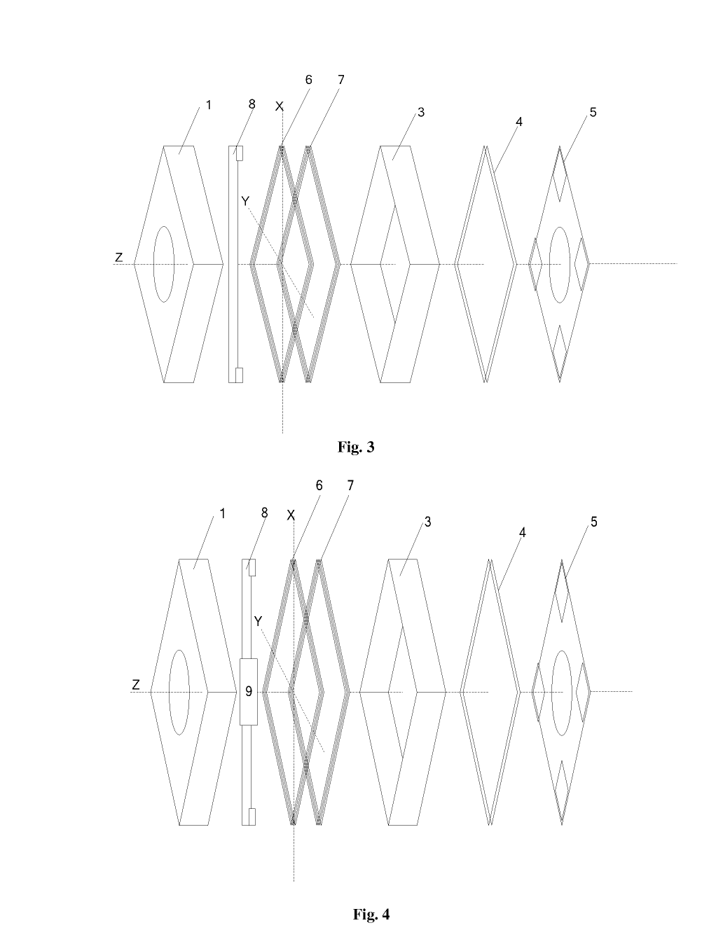

Reference is made to FIG. 2, which is a schematic diagram showing the structure of a camera motor according to an embodiment of the present application. In the coil set 2 according to this embodiment, the optical image stabilizer coil 6 is arranged close to the position of the lens assembly 1, and the autofocusing coil 7 is arranged close to the position of the holder 3.

That is to say, in this embodiment, after the autofocusing coil 7 is arranged on the holder 3, the optical image stabilizer coil 6 is then arranged in front of the autofocusing coil 7, and then the lens assembly 1 is assembled, to achieve arranging the optical image stabilizer coil 6 being close to the lens assembly 1.

the optical image stabilizer coil 6 for optical image stabilization applies a force by four groups of magnets in an X direction and a Y direction as in FIG. 2, and the autofocusing coil 7 for autofocus applies a force by one groups of magnets in a Z direction as in FIG. 2, therefore, arranging the optical image stabilizer coil 6 in front of the autofocusing coil 7 in this embodiment, the number of the optical image stabilizer coils 6 can be reduced, and thus the number of the coils in the coil set 2 may be reduced and further the volume of the camera motor may be reduced, further the overall volume of the device provided with the camera motor can be reduced.

In specific implementation, in the coil set 2 in this embodiment may be two optical image stabilizer coils and two metal components. Specifically, the optical image stabilizer coils and the metal components are arranged in a form of a ring-shaped structure, and each of the optical image stabilizer coils is arranged in a position opposite to a position of one of the metal components, connecting lines between the optical image stabilizer coils and the metal components corresponding to the optical image stabilizer coils are perpendicular to each other and intersect at a central point of the ring-shaped structure.

An acting force may be generated between each optical image stabilizer coil and a metal component corresponding to the optical image stabilizer coil, after the optical image stabilizer coil is energized.

Based on the structure of the above coil set 2, an acting force is generated between each optical image stabilizer coil and the metal component arranged corresponding to the optical image stabilizer coil after the optical image stabilizer coil is energized. Because of the square-shaped arrangement of the optical image stabilizer coils and the metal components in the ring-shaped structure of the camera motor, the two acting forces are the same in magnitude and are perpendicular to each other, thus, during practical application, the camera motor in this embodiment may maintain the stability of the camera motor during operation while effectively achieving the optical image stabilization.

Also, while the acting force is generated between each optical image stabilizer coil and the metal component corresponding to the optical image stabilizer coil, the electromagnet waves generated during interacting between the two optical stabilizer coils are avoided, and further the instability of the camera motor caused by intersecting of the electromagnet waves is avoided.

That is to say, in this embodiment, the instability of the camera caused by intersecting between the electromagnet waves is avoided by adopting the solution in which two optical image stabilizer coils are provided in the camera motor, the volume of the camera is reduced, the stability of the force applying for optical image stabilization in the camera motor is ensured.

The metal component may be a metal ball, such as a steel ball, to allow the steel ball to be magnetized by the optical image stabilizer coil at the position corresponding to the steel ball, thereby generating corresponding magnetic force, and ensuring the accuracy of the optical image stabilization while reducing the volume of the camera.

In addition, based on the implementation structure of the optical image stabilizer coil and the metal component hereinbefore, two autofocusing coils may be provided in the coil set 2. The autofocusing coils 4 are arranged respectively between two adjacent optical image stabilizer coils and between two adjacent metal components, a connecting line of each autofocusing coil and a corresponding magnet in the camera motor is perpendicular to a plane in which the ring-shaped structure is located, thus, an acting force is generated between each autofocusing coil and the magnet corresponding to the autofocusing coil after the autofocusing coil is energized, to pull the lens in the camera motor to move forward-and-backward, to further achieve autofocusing.

In another implementation, based on the implementation structure of the optical image stabilizer coil and the metal component hereinbefore, one autofocusing coil may be provided in the coil set 2, and the autofocusing coil is arranged between two adjacent metal components, and a connecting line between the autofocusing coil and the magnet in the camera motor is perpendicular to a plane in which the ring-shaped structure is located, thus, an acting force is generated between the autofocusing coiland the magnet 5 after the autofocusing coil is energized, to pull the lens in the camera motor to move forward-and-backward, to further achieve autofocusing.

In practical application, for further reducing the volume of the camera motor, an elastic component may be provided in the camera motor. The elastic component may be an element which bears and transmits a perpendicular load or a horizontal load and buffers and restricts the striking caused by a plane, and it functions to bear and transmit a perpendicular load or a horizontal load when an external force acts, to buffer and restricts the striking caused by an uneven plane such as a rough road. Reference is made to FIG. 3, a schematic diagram showing the structure of a camera motor is provided in an embodiment of the present application. In this embodiment, the camera motor may further include the following structure:

an elastic component 8, the elastic component 8 has a first end connected with the lens assembly 1, and a second end connected with the coil set 2.

Before the camera motor is started, the elastic component 8 is in a first elastic state.

That is to say, the elastic component 8 may bear and transmit the load between the lens assembly 1 and the coil set 2, and buffer and restrict the striking acting force between the lens assembly 1 and the coil set 2.

Therefore, in this embodiment, the elastic component 8 is used to provide an elastic acting force while stabilizing the optical image stabilizer coil 6 in the coil set 2 and the lens assembly 1, to reduce a forward pushing force and a backward drawing force to be provided by the autofocusing coil 7. For example, when the autofocusing coil 7 is required to push the lens assembly 1 to move forward, the elastic component 8 provides an acting force of rebounding, and when the autofocusing coil 7 is required to push the lens assembly 1 to move backward, the elastic component 8 may provide an acting force of tensioning, further the power to be provided by the autofocusing coil 7 for achieving the autofocus may be reduced, and further the number of the coils may be reduced, and the volume of the camera motor may be reduced further.

The first elastic condition may be a compression state, in this case, the elastic component 8 has a pushing acting force of rebounding, and the first elastic state may also be a stretch state, in this case, the elastic component 8 has a pulling acting force of drawing backward.

In practical implementation, the elastic component 8 may be grouped into two categories of metal and non-mental according to the material adopted, and in specific implementation of this embodiment, the elastic component 8 may be embodied as a spring, and the spring has a compression state or the stretch state.

Specifically, reference is made to FIG. 4, which is a schematic diagram showing another structure according to an embodiment of the present application. The camera motor may further include the following structure:

an elastic state setting structure 9, configured to set an elastic state of the elastic component 8 before the camera motor is started.

In practical application, the first elastic state of the elastic component 8 may be a compression state or may also be a stretch state of a spring. For example, in the case that the first elastic state of the elastic component 8 is a compression state, the camera motor in this embodiment may utilize the elastic component 8 to provide the power required to push the lens assembly 1 forward by the autofocusing coil 7, and further, the number of the autofocusing coils 7 may be reduced in this embodiment; and in the case that the first elastic state of the elastic component 8 is a stretch state, the camera motor in this embodiment may utilize the elastic component 8 to provide the power required to draw the lens assembly 1 backward by the autofocusing coil 7, and further, the number of the autofocusing coils 7 may be reduced in this embodiment. Therefore, in specific implementation of this embodiment, the number of the coils can be reduced, to reduce the volume of the camera motor.

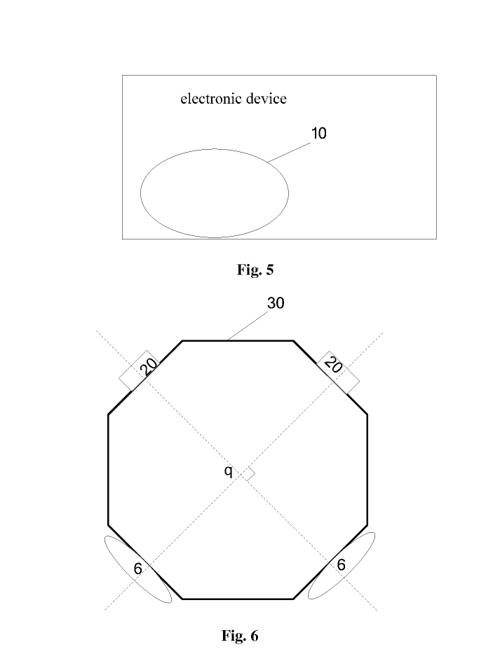

Reference is made to FIG. 5, which is a schematic diagram showing the structure of an electronic device according to an embodiment of the present application. The electronic device includes a camera motor 10.

The camera motor 10 includes the following structures:

a lens assembly 1, a coil set 2, a holder 3, a coil bobbin assembly 4 and a base 5. The coil set 2 includes an optical image stabilizer coil 6 and an autofocusing coil 7.

The lens assembly 1 is connected with the coil set 2, the coil set 2 is arranged in the holder 3, the holder 3 is arranged in the coil bobbin assembly 4, and the coil bobbin assembly 4 is arranged in the base 5.

It is to be noted that, the lens assembly 1 in this embodiment may be an assembly which has a square structure at an outer periphery and has a circular structure at an inner side, as shown in FIG. 1, to allow the circular lens to collect lights via the circular structure of its inner side and further to form an image.

The lens assembly 1 may be configured as a groove structure, as shown in FIG. 1, to allow other components including the coil set 2 to be moved towards a left side in FIG. 1, and further to be embedded into the lens assembly 1, to achieve the connection of the lens assembly 1 and the coil set 2 to each other.

In practical application, the coil set 2 may be arranged in the holder 3. For the coil set 2, the holder 3 may function to support the coils to maintain a certain shape, and the holder 3 can be arranged in the coil bobbin assembly 4, and the coil set 2 is supported by the coil bobbin assembly 4 via the holder.

Correspondingly, the coil bobbin assembly 4 may be embedded into the base 5, and the base 5, after enclosing the coil bobbin assembly 4, the holder 3, the coil set 2, is connected with the lens assembly 1, for example, by snap-fit connection or nested connection.

As shown in FIG. 1, the coil set 2 may achieve the forward-and-backward moving of the lens assembly 1 simply by pushing the lens assembly 1 in front of the coil set 2, without requiring pushing the structures such as the holder 3, and the coil bobbin assembly 4, and further without requiring a large pushing force, therefore the number of the coils in the coil set may be reduced, and thus the volume of the coil set may be reduced.

As can be seen from the above solution, in the electronic device according to the this embodiment of the present application, by changing the mounting sequence of the coil bobbin assembly and the coil set in its camera motor, that is to say, the lens assembly in the camera motor is connected with the coil set, the coil set is arranged in the holder, the holder is arranged in the coil bobbin assembly, and the coil bobbin assembly is then arranged in the base, the power which is required to be provided by the coil set in pushing is reduced, thus may reduce the volume of the coil, and further reduce the volume of the camera motor and the overall weight of the electronic device provided with the camera motor, and improve an experience of a user during using, and achieve the object of this embodiment.

In the electronic device according to this embodiment, in the coil set 2 according to this embodiment, the optical image stabilizer coil 6 is arranged close to the position of the lens assembly 1, and the autofocusing coil 7 is arranged close to the position of the holder 3. As shown in FIG. 2.

That is to say, in this embodiment, after the autofocusing coil 7 is arranged on the holder 3, the optical image stabilizer coil 6 is then arranged in front of the autofocusing coil 7, and then the lens assembly 1 is assembled, to achieve arranging the optical image stabilizer coil 6 being close to the lens assembly 1.

The optical image stabilizer coil 6 for optical image stabilization applies a force by four groups of magnets in an X direction and a Y direction as in FIG. 2, and the autofocusing coil 7 for autofocus applies a force by one groups of magnets in a Z direction as in FIG. 2. Therefore, arranging the optical image stabilizer coil 6 in front of the autofocusing coil 7 in this embodiment, the number of the optical image stabilizer coils 6 can be reduced, and thus the number of the coils in the coil set 2 may be reduced and further the volume of the camera motor may be reduced, further the overall volume of the electronic device provided with the camera motor can be reduced.

In practical application, for further reducing the volume of the camera motor and the electronic device, an elastic component may be provided in the camera motor of the electronic device. The elastic component may be an element which bears and transmits a perpendicular load or a horizontal load and buffers and restricts the striking caused by a plane, and it functions to bear and transmit a perpendicular load or a horizontal load when an external force acts, to buffer and restricts the striking caused by an uneven plane such as a rough road. As shown in FIG. 3, in the electronic device according to this embodiment, the camera motor 10 may further include the following structure:

an elastic component 8, the elastic component 8 has a first end connected with the lens assembly 1, and a second end connected with the coil set 2.

Before the camera motor 10 is started, the elastic component 8 is in a first elastic state.

That is to say, the elastic component 8 may bear and transmit the load between the lens assembly 1 and the coil set 2, and buffer and restrict the striking acting force between the lens assembly 1 and the coil set 2.

Therefore, in the electronic device according to this embodiment, the elastic component 8 in the camera motor 10 is used to provide an elastic acting force while stabilizing the optical image stabilizer coil 6 in the coil set 2 and the lens assembly 1, to reduce a forward pushing force and a backward drawing force to be provided by the autofocusing coil 7. For example, when the autofocusing coil 7 is required to push the lens assembly 1 to move forward, the elastic component 8 provides an acting force of rebounding, and when the autofocusing coil 7 is required to push the lens assembly 1 to move backward, the elastic component 8 may provide an acting force of tensioning, further the power to be provided by the autofocusing coil 7 for achieving the autofocus may be reduced, and further the number of the coils may be reduced, and the volume of the camera motor may be reduced further.

The first elastic condition may be a compression state, in this case, the elastic component 8 has a pushing acting force of rebounding, and the first elastic state may also be a stretch state, in this case, the elastic component 8 has a pulling acting force of drawing backward.

In practical implementation, the elastic component 8 may be grouped into two categories of metal and non-mental according to the material adopted, and in specific implementation of this embodiment, the elastic component 8 may be embodied as a spring, and the spring has a compression state or the stretch state.

Specifically, as shown in FIG. 4, in the electronic device according to this embodiment, the camera motor may further include the following structure:

an elastic state setting structure 9, configured to set an elastic state of the elastic component 8 before the camera motor 10 is started.

In practical application, the first elastic state of the elastic component 8 may be a compression state or may also be a stretch state of a spring. For example, in the case that the first elastic state of the elastic component 8 is a compression state, the camera motor in this embodiment may utilize the elastic component 8 to provide the power required to push the lens assembly 1 forward by the autofocusing coil 7, and further, the number of the autofocusing coils 7 may be reduced in this embodiment; and in the case that the first elastic state of the elastic component 8 is a stretch state, the camera motor in this embodiment may utilize the elastic component 8 to provide the power required to draw the lens assembly 1 backward by the autofocusing coil 7, and further, the number of the autofocusing coils 7 may be reduced in this embodiment. Therefore, in specific implementation of the electronic device according to this embodiment, the number of the coils can be reduced, to reduce the volume of the camera motor and the electronic device, to further improve the experience of the user during using.

Besides, currently, in a camera motor of a mobile device such as a cellphone, magnetic coils are generally used to provide a power for image stabilization, and in a ring-shaped frame of a camera motor, four symmetrically distributed image-stabilizing magnetic coils are provided. Two image-stabilizing magnetic coils at opposite positions will generate electromagnetic waves in an X direction and a Y direction after being energized, to generate an acting force to push the lens connected with the frame to move in the X direction and the Y direction, thus stabilizing the lens.

In the camera motor, the electromagnet waves intersect in the X direction and the Y direction, and the intersection of the electromagnetic waves may cause instability of the motor in a certain degree, and lens shaking occurs.

Reference is made to FIG. 6, which is a schematic diagram showing the structure of a camera motor according to an embodiment of the present application; specifically, the camera motor in this embodiment may be arranged in a device with a camera function, such as a cellphone, a pad, and a single-lens reflex camera.

In this embodiment, the camera motor may include the following structures:

at least two optical image stabilizer coils 6 and at least two metal components 20.

Specifically, the optical image stabilizer coils 6 and the metal components 20 are arranged in a form of a ring-shaped structure 30, and each optical image stabilizer coil 6 is arranged in a position opposite to a position one metal component 20, connecting lines between the optical image stabilizer coils 6 and the metal components 20 opposite thereto are perpendicular to each other and intersect with each other at a central point q of the ring-shaped structure 30.

An acting force is generated between each of the optical image stabilizer coils band a metal component 20 corresponding thereto when optical image stabilizer coils 6 are energized.

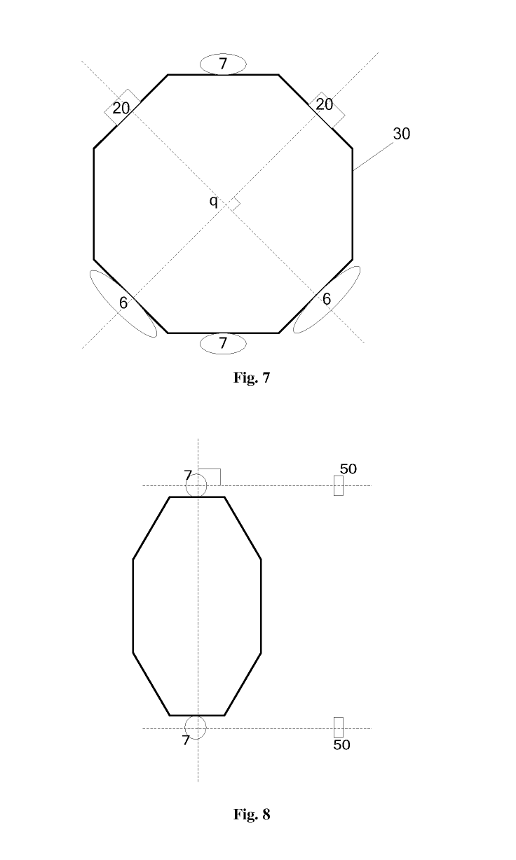

In this embodiment, the camera motor including therein two optical image stabilizer coils 6 and two metal components 20 is taken as an example. In this embodiment, the two optical image stabilizer coils 6 and the two metal components 20 in the camera motor are arranged in the form the ring-shaped structure 30, as shown in FIG. 6, the two optical image stabilizer coils 6 are arranged adjacent to each other in the ring-shaped structure 30, and the two metal components 20 are also arranged adjacent to each other in the ring-shaped structure 30. Each optical image stabilizer coil 6 is arranged opposite one metal component 20, and connecting lines between the optical image stabilizer coils 6 and the metal components 20 opposite thereto are perpendicular to each other and intersect with each other at the central point q. As shown in FIG. 7, in the ring-shaped structure 30 of the camera motor, the two optical image stabilizer coils 6 and the two metal components 20 are arranged uniformly so as to form a square.

Therefore, an acting force is generated between each of the optical image stabilizer coils 6 and the respective metal component 20 arranged opposite thereto when optical image stabilizer coils 6 are energized. Because of the square arrangement structure of the optical image stabilizer coils 6 and the metal components 20 in the ring-shaped structure 30 of the camera motor, two such acting forces are the same in magnitude, and opposite and perpendicular to each other, thereby, in the practical application of the camera motor in this embodiment, an optical image stabilization can be achieved effectively, thus keeping stabilization in the operation of the camera motor.

Furthermore, while the acting force is generated between each of the optical image stabilizer coils 6 and the metal component 20 corresponding thereto, electromagnetic waves are prevented from being generated between the two optical image stabilizer coils as interacting with each other, and thus instability of the camera motor from being caused by the intersection of the electromagnetic waves is avoided, such that the object of this embodiment is achieved.

As can be seen from the above solution, in the camera motor according to the embodiment of the present application, by providing the metal components in positions opposite to those of the two optical image stabilizer coils in the camera motor, an acting force is generated between the optical image stabilizer coiland the metal component corresponding thereto when optical image stabilizer coil is energized, and optical image stabilization may be achieved, and also there will be no electromagnetic waves between the optical image stabilizer coil and the metal component, such that there will be no intersecting electromagnetic waves in the camera motor, thereby avoiding instability of the camera motor and lens shaking occurring caused by intersecting of the electromagnetic waves, thus achieving the object of this embodiment.

In addition, in practical application, a magnet 50 is provided in the camera motor, to generate an acting force for autofocus between the metal coil and the magnet 50.

Reference is made to FIG. 7, a schematic diagram showing the structure of a camera motor according to an embodiment of the present application is provided; specifically, the camera motor in this embodiment may further include:

at least two autofocusing coils 7.

The autofocusing coils 7 are arranged respectively between two adjacent optical image stabilizer coils 6, and between two adjacent metal components 20, and a connecting line between each of the autofocusing coils 7 and a magnet 50 corresponding thereto in the camera motor is perpendicular to a plane in which the ring-shaped structure 30 is located.

An acting force is generated between each of the autofocusing coils land a magnet 50 corresponding thereto after autofocusing coils 7 are energized.

In this embodiment, the camera motor including two optical image stabilizer coils 6 and two metal components 20 is taken as an example, in this embodiment, the camera motor further has two autofocusing coils 7, and these two autofocusing coils 7 are respectively arranged between the two optical image stabilizer coils 6 and between the two metal components 20, as shown in FIG. 7.

In practical application, a magnet is provided in the camera motor, an acting force for autofocus is generated between the magnet and the metal coil. In this embodiment, the two autofocusing coils 7 provided in the camera motor are respectively arranged in the positions shown in FIG. 7, accordingly, the magnets 50 in the camera motor are arranged in positions corresponding to those of the two autofocusing coils 7, as shown in FIG. 8, connecting lines between the two autofocusing coils 7 and the magnets 50 arranged corresponding to the autofocusing coils 7 are perpendicular to the plane in which the ring-shaped structure 30 is located. Thus, when each of the autofocusing coils 7 is energized, an acting force may be generated between each of the autofocusing coils 7 and the magnet 50 arranged corresponding thereto, to pull the lens in the camera motor to move forward and backward, to further achieve autofocusing.

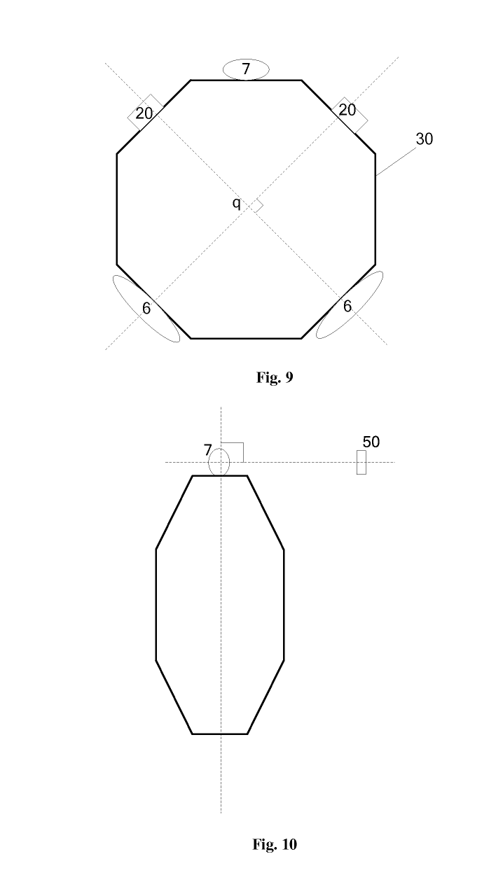

Reference is made to FIG. 9, which is a schematic diagram showing the structure of a camera motor according to an embodiment of the present application; specifically, the camera motor in this embodiment may further include the following structure:

one autofocusing coil 7.

The autofocusing coil 7 is arranged between two adjacent metal components 20, and a connecting line of the autofocusing coil 7 and the magnet 50 in the camera motor is perpendicular to the plane in which the ring-shaped structure 30 is located.

An acting force may be generated between the autofocusing coil 7 and the magnet 50 after the autofocusing coil 7 is energized.

In specific implementation, the camera motor including two optical image stabilizer coils 6 and two metal components 20 is taken as an example in this embodiment. In this embodiment, the camera motor further has one autofocusing coil 7, and the autofocusing coil 7 is arranged between the two metal components 20, as shown in FIG. 9.

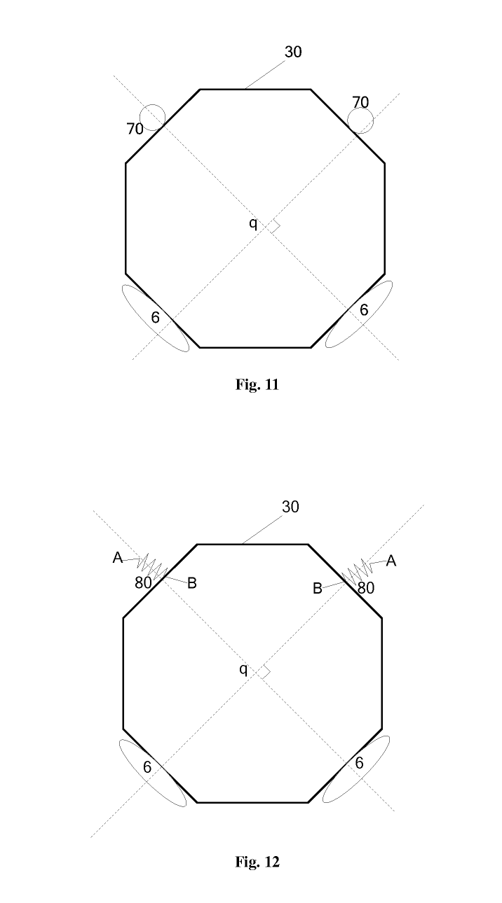

In practical application, a magnet is provided in the camera motor, an acting force for autofocus is generated between the magnet and the metal coil. In this embodiment, one autofocusing coil 7 provided in the camera motor is arranged at a position as shown in FIG. 9, correspondingly, the magnet 50 in the camera motor and the autofocusing coil 7 are arranged in corresponding positions, as shown in FIG. 10, and a connecting line of the autofocusing coil 7 and the magnet 50 arranged corresponding to the autofocusing coil 7 is perpendicular to the plane in which the ring-shaped structure 30 is located, thus, after the autofocusing coil 7 is energized, an acting force may be generated between the autofocusing coil 7 and the magnet 50 arranged corresponding to the autofocusing coil 7, to pull the lens in the camera motor to move forward and backward, and further achieve autofocusing.

In the present application, the solution of providing two optical image stabilizer coils in the camera motor is adopted to avoid the situation of instability of the camera occurred due to intersection of electromagnetic waves, the volume of the camera is reduced while achieving such an object that the stability of applying a force for optical image-stabilization in the camera motor is ensured.

In specific application, reference is made to FIG. 11, which is a schematic diagram showing the structure of a camera motor according to an embodiment of the present application. The metal component 20 in the camera motor of this embodiment can be a metal ball 70, such that when the optical image stabilizer coil 6 moves after being energized, the optical image stabilizer coil 6 may be returned to its original position by a magnetic force between the metal ball 70 and the optical image stabilizer coil 6.

Specifically, in this embodiment, the metal component 20 may be a steel ball, such that the optical image stabilizer coil 6 in a position corresponding to that of the steel ball magnetizes the steel ball so as to produce a magnetic force, thus ensuring accuracy of the optical image stabilization while reducing the volume of the camera.

In addition, in specific implementation, reference is made to FIG. 12, which is a schematic diagram showing the structure of a camera motor according to an embodiment of the present application. The metal component 20 in the camera motor of this embodiment may also be embodied as a spring component 80, the spring component 80 has a first end A arranged at one point of the camera motor, and has a second end B arranged at a position corresponding to that of an optical image stabilizer coil 6 corresponding to the spring component 80, such that when the optical image stabilizer coil 6 moves after being energized, the the optical image stabilizer coil may be returned to its original position by an elastic force from the spring component 80.

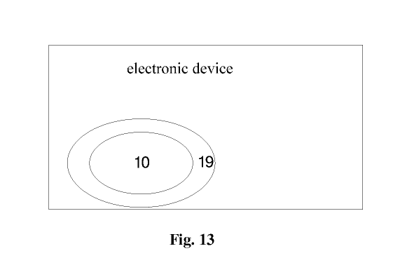

Reference is made to FIG. 13, which is a schematic diagram showing the structure of an electronic device according to an embodiment of the present application; specifically, the electronic device has a camera 19 therein, and the camera has a camera motor 10 therein, as shown in FIG. 13. In this embodiment, the electronic device can be a cellphone, a pad, a single-lens reflex camera etc.

Specifically, the structure of the camera motor 10 can be any structure of the embodiments described above, as the structure in FIG. 6, the camera motor 10 may include the following structures:

at least two optical image stabilizer coils 6 and at least two metal components 20.

Specifically, the optical image stabilizer coils 6 and the metal components 20 are arranged in a form of a ring-shaped structure 30, and each of the optical image stabilizer coils 6 is arranged in a position opposite to a position of one metal component 20, connecting lines between the optical image stabilizer coils 6 and the metal components 20 opposite thereto are perpendicular to each other and intersect with each other at a central point q of the ring-shaped structure 30;

An acting force is generated between each of the optical image stabilizer coils 6 and a metal component 20 corresponding thereto when optical image stabilizer coils 6 are energized.

In this embodiment, the camera motor including therein two optical image stabilizer coils 6 and two metal components 20 is taken as an example. In this embodiment, the two optical image stabilizer coils 6 and the two metal components 20 in the camera motor are arranged in the form the ring-shaped structure 30, as shown in FIG. 6, the two optical image stabilizer coils 6 are arranged adjacent to each other in the ring-shaped structure 30, and the two metal components 20 are also arranged adjacent to each other in the ring-shaped structure 30, and each optical image stabilizer coils 6 is arranged opposite to one metal components 20, and connecting lines between the optical image stabilizer coils 6 and the metal components 20 opposite thereto are perpendicular to each other and intersect with each other at the central point q. As shown in FIG. 7, in the ring-shaped structure 30 of the camera motor, the two optical image stabilizer coils 6 and the two metal components 20 are arranged uniformly so as to form a square.

Therefore, an acting force is generated between each of the optical image stabilizer coils 6 and the respective metal component 20 arranged opposite thereto when optical image stabilizer coils 6 are energized. Because of the square arrangement structure of the optical image stabilizer coils 6 and the metal components in the ring-shaped structure 30 of the camera motor, two such acting forces are the same in magnitude, and opposite and perpendicular to each other, thereby, in the practical application of the camera motor in this embodiment, an optical image stabilization can be achieved effectively, thus keeping stabilization in the operation of the camera motor, and improving definition of image outputted by the camera 19.

Furthermore, while the acting force is generated between each of the optical image stabilizer coils 6 and the metal component 20 corresponding thereto, electromagnetic waves are prevented from being generated between the two optical image stabilizer coils as interacting with each other, and thus instability of the camera motor from being caused by the intersection of the electromagnetic waves is avoided, such that the object of this embodiment is achieved.

As can be seen from the above solution, in the electronic device according to the embodiment of the present application, by providing the metal components in positions opposite to those of the two optical image stabilizer coils in the camera motor, an acting force is generated between the optical image stabilizer coil and the metal component corresponding thereto when optical image stabilizer coil is energized, and optical image stabilization may be achieved, and also there will be no electromagnetic waves between the optical image stabilizer coil and the metal component, such that there will be no intersecting electromagnetic waves in the camera motor, thereby avoiding instability of the camera motor and lens shaking occurring caused by intersecting of the electromagnetic waves, thus achieving the object of this embodiment.

In addition, in practical application, a magnet 50 is provided in the camera motor, to generate an acting force for autofocus between the metal coil and the magnet 50.

Accordingly, as shown in FIG. 7, the camera motor 10 in the camera 19 in the electronic device according to this embodiment may further includes the following structures:

at least two autofocusing coils 7.

The autofocusing coils 7 are each arranged respectively between two adjacent optical image stabilizer coils 6, and between two adjacent metal components 20, and a connecting line of each of the autofocusing coils 7 and a magnet 50 corresponding thereto in the camera motor is perpendicular to a plane in which the ring-shaped structure 30 is located.

An acting force is generated between each of the autofocusing coils 7 and a magnet 50 corresponding thereto after autofocusing coils 7 are energized.

In this embodiment, the camera motor including two optical image stabilizer coils 6 and two metal components 20 is taken as an example, in this embodiment, the camera motor further has two autofocusing coils 7, and these two autofocusing coils 7 are respectively arranged between the two optical image stabilizer coils 6 and between the two metal components 20, as shown in FIG. 7.

In practical application, a magnet is provided in the camera motor, an acting force for autofocus is generated between the magnet and the metal coil. In this embodiment, the two autofocusing coils 7 provided in the camera motor are respectively arranged in the positions shown in FIG. 7, accordingly, the magnets 50 in the camera motor are arranged in positions corresponding to those of the two autofocusing coils 7, as shown in FIG. 8, connecting lines between the two autofocusing coils 7 and the magnets 50 arranged corresponding thereto are perpendicular to the plane in which the ring-shaped structure 30 is located. Thus, when each of the autofocusing coils 7 is energized, an acting force may be generated between each of the autofocusing coils 7 and the magnet 50 arranged corresponding thereto, to pull the lens in the camera motor to move forward and backward, to further achieve autofocusing.

In addition, as shown in FIG. 9, the camera motor 10 in the camera 19 in the electronic device according to this embodiment may further include the following structure:

one autofocusing coil 7.

The autofocusing coil 7 is arranged between two adjacent metal components 20, and a connecting line of the autofocusing coil 7 and the magnet 50 in the camera motor is perpendicular to the plane in which the ring-shaped structure 30 is located.

An acting force may be generated between the autofocusing coil 7 and the magnet 50 after the autofocusing coil 7 is energized.

In specific implementation, the camera motor including two optical image stabilizer coils 6 and two metal components 20 is taken as an example in this embodiment. In this embodiment, the camera motor further has one autofocusing coil 7, and the autofocusing coil 7 is arranged between the two metal components 20, as shown in FIG. 9.

In practical application, a magnet is provided in the camera motor, an acting force for autofocus is generated between the magnet and the metal coil. In this embodiment, one autofocusing coil 7 provided in the camera motor is arranged at a position as shown in FIG. 9, correspondingly, the magnet 50 in the camera motor and the autofocusing coil 7 are arranged in corresponding positions, as shown in FIG. 10, and a connecting line of the autofocusing coil 7 and the magnet 50 arranged corresponding to the autofocusing coil 7 is perpendicular to the plane in which the ring-shaped structure 30 is located, thus, after the autofocusing coil 7 is energized, an acting force may be generated between the autofocusing coil 7 and the magnet 50 arranged corresponding to the autofocusing coil 7, to pull the lens in the camera motor to move forward and backward, and further achieve autofocusing.

In the present application, the solution of providing two optical image stabilizer coils 6 in the camera motor 10 in the camera 19 is adopted to avoid the situation of instability of the camera occurred due to intersection of electromagnetic waves, the volume of the camera is reduced while achieving such an object that the stability of applying a force for optical image-stabilization in the camera motor is ensured.

In specific application, as shown in FIG. 11, the metal component 20 in the camera motor 10 in the camera 19 in the electronic device in this embodiment may be a metal ball 70, such that when the optical image stabilizer coil 6 moves after being energized, the optical image stabilizer coil 6 may be returned to its original position by a magnetic force between the metal ball 70 and the optical image stabilizer coil 6.

Specifically, in this embodiment, the metal component 20 may be a steel ball, such that the optical image stabilizer coil at a position corresponding to that of the steel ball magnetizes the steel ball so as to produce a magnetic force, thus ensuring accuracy of the optical image-stabilization while reducing the volume of the camera.

In addition, in specific implementation, as shown in FIG. 12, the metal component 20 of the camera motor 10 in the camera 19 in the electronic device according to this embodiment may also be embodied as a spring component 80, and the spring component 80 has a first end A arranged at one point of the camera motor and has a second end B arranged in a position corresponding to that of an optical image stabilizer coil 6 corresponding to the spring component 80, such that when the optical image stabilizer coil 6 moves after being energized, the optical image stabilizer coil 6 may be returned to its original position by an elastic force from the spring component 80.

It should be noted that, various embodiments in the specification are described in a progressive way, each embodiment lays emphasis on difference from other embodiments, and for the same or similar parts between various embodiments, one may refer to the description of other embodiments.

In addition, terms “comprise”, “include” or any other variation thereof intends to be understood in a non-exclusive sense, so that an object or a device including a series of elements not only includes these elements, but also includes other elements not explicitly listed, or further includes elements inherent in the object or the device. In the absence of more restrictions, an element defined by a sentence “includes a . . . ” does not exclude other same elements which may also exist in the object or the device including said element.

A camera motor and an electronic device according to the present application are described in detail hereinbefore. The principle and the embodiments of the present application are illustrated herein by specific examples. The above description of examples is only intended to help the understanding of the method and idea of the present application. Also, for an ordinary skilled person in the field, based on the concept of the present application, variations may be made in both of the specific embodiments and the application scope, in summary, the contents of this specification should not be construed as limiting to the present application.

1. A camera motor, comprising:
a lens assembly, a coil set, a holder, a coil bobbin assembly and a base, the coil set comprising an optical image stabilizer coil and an autofocusing coil;
wherein the lens assembly is connected with the coil set, and the coil set is arranged in the holder, and the holder is arranged in the coil bobbin assembly, and the coil bobbin assembly is arranged in the base.

2. The camera motor according to claim 1, wherein in the coil set, the optical image stabilizer coil is arranged close to the lens assembly, and the autofocusing coil is arranged close to the holder.

3. The camera motor according to claim 1, further comprising:
an elastic component with a first end connected with the lens assembly, and with a second end connected with the coil set;
wherein the elastic component is in a first elastic state before the camera motor is started.

4. The camera motor according to claim 3, wherein the elastic component comprises a spring.

5. The camera motor according to claim 3, further comprising:
an elastic state setting structure, configured to set an elastic state of the elastic component before the camera motor is started.

6. The camera motor according to claim 3, wherein the first elastic state is a compression state or a stretch state.

7. The camera motor according to claim 1, wherein:
the number of the optical image stabilizer coils is at least two, and the coil set further comprises at least two metal components;
the optical image stabilizer coils and the metal components are arranged in a form of a ring-shaped structure, and each of the optical image stabilizer coils is arranged in a position opposite to a position of one of the metal components, and connecting lines between the optical image stabilizer coils and the metal components opposite to the optical image stabilizer coils are perpendicular to each other and intersect with each other at a central point of the ring-shaped structure;
wherein an acting force is generated between each optical image stabilizer coiland a metal component corresponding to the optical image stabilizer coil when the the optical image stabilizer coil is energized.

8. The camera motor according to claim 7, wherein:
the number of the autofocusing coils is at least two;
the autofocusing coils are respectively arranged between two adjacent optical image stabilizer coils and between two adjacent metal components, and a connecting line of each autofocusing coil and a magnet corresponding to the autofocusing coil in the camera motor is perpendicular to a plane in which the ring-shaped structure is located;
an acting force is generated between each autofocusing coiland the magnet corresponding to the autofocusing coil when the autofocusing coil is energized.

9. The camera motor according to claim 7, wherein:
the number of the autofocusing coils is one;
the autofocusing coil is arranged between two adjacent metal components, and a connecting line of the autofocusing coil and a magnet in the camera motor is perpendicular to the plane in which the ring-shaped structure is located;
wherein an acting force is generated between the autofocusing coil and the magnet when the autofocusing coil is energized.

10. The camera motor according to claim 7, wherein:
the metal component comprises a metal ball, wherein the optical image stabilizer coil is returned to an original position of the optical image stabilizer coil under a magnetic force between the metal ball and the optical image stabilizer coil when the optical image stabilizer coil moves after being energized.

11. The camera motor according to claim 10, wherein the metal ball comprises a steel ball.

12. The camera motor according to claim 7, wherein:
the metal component comprises: a spring component, the spring component has a first end arranged at one point of the camera motor, and has a second end arranged at a position corresponding to a position of the optical image stabilizer coil corresponding to the spring component, wherein when the optical image stabilizer coil moves after being energized, the optical image stabilizer coil is returned to its original position by the spring component under an elastic force.

13. An electronic device, comprising a camera motor;
wherein the camera motor comprises:
a lens assembly, a coil set, a holder, a coil bobbin assembly and a base, the coil set comprising an optical image stabilizer coil and an autofocusing coil;
wherein the lens assembly is connected with the coil set, and the coil set is arranged in the holder, and the holder is arranged in the coil bobbin assembly, and the coil bobbin assembly is arranged in the base.

14. The electronic device according to claim 13,
wherein in the coil set, the optical image stabilizer coil is arranged close to the lens assembly, and the autofocusing coil is arranged close to the holder.

15. The electronic device according to claim 13, wherein the camera motor further comprises:
an elastic component which has a first end connected with the lens assembly, and a second end connected with the coil set;
wherein the elastic component is in a first elastic state before the camera motor is started.

16. The electronic device according to claim 15, wherein the camera motor further comprises:
an elastic state setting structure, configured to set an elastic state of the elastic component before the camera motor is started.

17. The electronic device according to claim 13, wherein:
the number of the optical image stabilizer coils is at least two and the coil set further comprises at least two metal components;
the optical image stabilizer coils and the metal components are arranged in a form of a ring-shaped structure, and each of the optical image stabilizer coils is arranged in a position opposite to a position of one of the metal components, and connecting lines between the optical image stabilizer coils and the metal components opposite to the optical image stabilizer coils are perpendicular to each other and intersect with each other at a central point of the ring-shaped structure;
wherein an acting force is generated between each optical image stabilizer coil and a metal component corresponding to the optical image stabilizer coil when the optical image stabilizer coil is energized.

18. The electronic device according to claim 17, wherein a magnet is further provided in the camera;
the number of the autofocusing coils is at least two;
wherein the autofocusing coils are respectively arranged between two adjacent optical image stabilizer coils and between two adjacent metal components, and a connecting line of each autofocusing coil and a magnet corresponding to the autofocusing coil in the camera motor is perpendicular to a plane in which the ring-shaped structure is located;
wherein an acting force is generated between each autofocusing coils and the magnet corresponding to the autofocusing coil when the autofocusing coil is energized.

19. The electronic device according to claim 17, wherein a magnet is further provided in the camera;
the number of the autofocusing coils is one;
the autofocusing coil is arranged between two adjacent metal components, and a connecting line of the autofocusing coil and a magnet in the camera motor is perpendicular to the plane in which the ring-shaped structure is located;
wherein an acting force is generated between the autofocusing coil and the magnet when the autofocusing coil is energized.

20. The electronic device according to claim 17, wherein:
the metal component comprises a metal ball, the optical image stabilizer coil is returned to an original position of the optical image stabilizer coil under a magnetic force between the metal ball and the optical image stabilizer coil when the optical image stabilizer coil moves after being energized.
